(19) United States
(12) Patent Application Publication
(10) Pub. No.: US 2007/0094267 A1
(43) Pub. Date: Apr. 26, 2007

(54) Method and system for website navigation

(75) Inventors: Frederick L. Good, Cambridge, MA (US); Thuy Tu Pham, Norwood, MA (US); Craig Stuber, Kensington, NH (US)

Correspondence Address: KRAMER & AMADO, P.C., 1725 DUKE STREET, SUITE 240, ALEXANDRIA, VA, 22314, US

(73) Assignee: GLOGOOD INC., Cambridge, MA (US)

(21) Appl. No.: 11/253,645

(22) Filed: Oct. 20, 2005

(51) Int. Cl. G06F 17/30

(52) U.S. Cl. 707/10

(57) ABSTRACT

A method and system for web site navigation utilize an internet browser for navigating a plurality of web pages that are configured by a web server. The plurality of web pages are linked as a first set of web pages and linked as at least a second set of web pages. A jump control section is provided on a navigation bar to the user to provide a visual indication of a total number of the first set of linked web pages. The jump control section also provides a jump box and a jump control button which allow the user to immediately jump to any page within the web site. The jump page box displays the current page number when not activated by the user. The navigation bar also includes a strolling control section that permits the user to stroll through a subset of related web pages, identified as the second set, without requiring the user to reload a web site directory page. The strolling control section also provides a visual indication of the total number of web pages within the subset and the current page number within the subset. A status location indicator is also provided on the navigation bar to indicate a text name of the currently displayed subset. The user may conduct telephone communication with a web site guide, such as a web site help desk, and immediately jump to a desired web page by way of the jump control section without the need to navigate a complicated hierarchy of web pages and hyperlinks.

### FIELD OF THE INVENTION

The present invention generally relates to a method and system for web site navigation. More particularly, the present invention relates to navigation of web sites that catalog large numbers of graphic and textual elements among large numbers of web pages.

### BACKGROUND OF THE INVENTION

Navigating a traditional web site is an increasingly fractured process. Virtually all of today's websites were created pre-broadband and many are mosaics of third party services with different navigation systems. Download speed and refresh rates have dictated page content, page structure and the flow of page content. Text, not graphics, complex page content not simplicity, and multiple third party services with various user interfaces are the norm. Simple web site navigation fails as traditional web sites increases in page count, graphic content, buttons and services offered. This traditional web site creation environment detracts from a simple user navigation system.

The number of active web sites available on the world wide web is currently about 35 million growing at about 1 million per month. Search engines, such as Google, currently index over 8.2 billion web pages to assist users in locating information. This number is expected to increase.

Web sites are traditionally stored on a server and include textual and graphical information arranged according to a predetermined protocol. The protocol may take a variety of forms such as the static form HTML (“Hyper Text Markup Language”) having fixed tag semantics and a fixed tag set, or a dynamic form such as SGML (“Standard Generalized Markup Language”) having dynamic tag sets defined by ISO 8879. XML (“extensible Markup Language”) is a subset of SGML, and is optimized for delivery of content over the world wide web. Web sites are then traditionally interpreted by a client program, such as Microsoft (R) Internet Explorer (R), which resides on a user computer. In general, the protocol of the web site, whether created in HTML, SGML, or XML, is transparent to the end user (i.e. the client program on the user computer).

Web sites may be relatively simple, consisting of one or a few linked pages, or exceptionally complex, including literally thousands of pages with many services. A simple form of a web site is a blog, which generally consists of a single page including a short list of chronologically arranged entries resembling a diary of information. However, complex web sites generally include a large number of self linking web pages that are arranged according to a predetermined structure.

FIG. 1 (PRIOR ART) schematically illustrates a traditional hierarchical structure 100 having web pages linked according to a parent/child node configuration. Home page 102 is linked to a plurality of separate sub pages 104, 106, 108, and 110 using hyperlinks. When a hyperlink on home page 102 is selected by a pointing device, such as a mouse pointer, the selected web page is loaded into a user program, known as a web browser, for display on the user computer. The sub pages 104, 106, 108, and 110 may also contain links to the other web pages within the web site or may optionally link to other web sites on the web.

FIG. 2 (PRIOR ART) schematically illustrates a home page 102, as displayed by a browser on a user computer, that includes a site map 112, a graphic element 113, and text 115. The site map 112 is a directory of a plurality of hyperlinks 114, 116, 118, 120, that respectively link to sub pages 104, 106, 108, and 110. Thus, when a user selects a hyperlink, e.g. hyperlink 114, from site map 112, the corresponding web page, e.g. 104, is loaded into the web browser for display. The creation of the hyperlinks, whether manually using HTML or dynamically using an Internet development platform such as ASP or JSP, is transparent to the user.

A common navigation objective when creating a traditional web site is a consistent look and feel between the sub pages to remind the user that they are still viewing of the same web site even if they are not. For example, a web site may use a consistent color and layout scheme between pages, and may provide consistent placement of graphic elements, text and hyperlinks, in an effort to foster familiarity to the user. However, as may be expected, content between pages may require a different number and size of graphic elements or may require different amounts of text.

The challenges associated with web site design and navigation become exceptionally complex as the number of pages, graphic elements, buttons, and services offered increases. In web sites incorporating hundreds or thousands of web pages, the amount of labor required to load and place the graphic elements alone may reach hundreds of hours. Further, the amount of labor required to update the site map and dynamically link the web site pages increases with each additional page. Typically, expanding web site content by site designers supersedes simple navigation.

Traditional web sites have built upon a stand alone paradigm for web site navigation. This paradigm is efficient for relatively small web sites or web sites where broad keyword searching may effectively locate the desired information. However, traditional web site configurations do not adequately address the needs of complex web sites incorporating hundreds of pages. A traditional web site directory is often limited in scope, lacks a graphic reference and is not always accessible. Further, traditional web site configurations using a keyword form of indexing do not adequately address the needs of large-scale web-based catalogs where the desired items may have similar names, but may differ in configuration, application, and utilization. Additionally, traditional web sites do not provide a framework for efficient navigation with assistance from a telephone based, printed or electronic user guide or knowledgeable and experienced sales or service person.

### SUMMARY OF THE INVENTION

In accordance with one aspect of the present invention, a method and system for web site navigation is provided. A plurality of web pages are linked as a first set of web pages and linked as at least a second set of web pages. A jump control section is provided on a navigation bar to the user to provide a visual indication of a total number of the first set of linked web pages. The jump control section also provides a jump box and a jump control button which allow the user to immediately jump to any page within the web site. The jump page box displays the current page number when not activated by the user. The navigation bar also includes a strolling control section that permits the user to stroll through a subset of related web pages, identified as the second set, without requiring the user to reload a web site directory page. The strolling control section also provides a visual indication of the total number of web pages within the subset and the current page number within the subset. A Directory status location indicator is also provided on the navigation bar to indicate a text name of the currently displayed subset. The user may conduct telephone communication with a web site guide, such as a web site help desk, and immediately jump to a desired web page by way of the jump control section without the need to navigate a complicated hierarchy of web pages and hyperlinks.

A user desiring to locate U.S. patents related to, for example, “motorized lawmowers having the cutting blade height adjusted through movement of a wheel,” is first guided to the USPTO home page, http:**www.uspto.gov (hyperlink obtained by replacing ** with //). The user must first determine the appropriate class and subclass. Accordingly, the user is guided to click on “Patents” in the upper left hand column. Next, the user is guided midway to the middle column, under “Search Aids,” and requested to click on “Manual of Patent Classification.” Next, the user is guided to type in “56” for the Class of Harvesters, and “17.2” for the subclass “Having motor on ground-supported carrier, And cutter adjustable relative to ground, By adjusting ground wheel or skid relative to carrier.” By selecting the appropriate radio button, the user views the class definition to ensure that the information is correct.

In order to locate the appropriate patents, the user is re-directed back to the USPTO home page, and selects “Search” from the upper left hand column. At this page, the user clicks on “Advanced Search” to load yet another page, and then types in “CCL/56/17.2,“and clicks on the “Search” button—which is located midway down the page below the search query box. A listing of patents meeting the search criteria is then displayed to the user.

The user then places the mouse over the desired patent, and clicks to open a patent text file—which is yet another web page. In order to view an image, the user then clicks on “images” from the upper menu button, to view images of a selected patent. Only after proceeding to this step is a user enabled to advance through pages of the selected patent. However, in order to view additional patents within the selected Class and subclass, the user is required to re-select the page representing the listing of patents, and then select another patent.

The above scenario is typical across complex databases incorporating large numbers of web pages. Moreover, as demonstrated through the above example, button locations change from page to page. Given the various, and some-what arbitrary placement of buttons, hyperlinks, and text boxes throughout the different pages of a complex web site, it becomes apparent that the novice user may find difficulty in expeditiously finding the required information. Moreover, when navigating a complex web site with assistance, such as via telephone, the challenges facing the novice user become more apparent. A guide that communicates with the user via telephone is required to convey with words the location of buttons and/or hyperlinks, wait for a response from the user, and then convey the next location of buttons and/or hyperlinks. Communication is further delayed if the guide discovers that the user has made a typographical mistake or selected an improper hyperlink.

In accordance with an aspect of the present invention, each page of a web site is provided with a unique page number for purposes of identification. A uniform navigation bar is viewable from all pages of the web site to facilitate navigation control and provide immediate access to all web pages. A text box for entering a unique page number is provided in the navigation bar. Accordingly, during telephone assistance from a guide, a unique page number may be conveyed to the user, who may then enter the number into the text box. When the user clicks onto a jump control button, e.g. “Go,” the user is immediately directed to the desired web page. Sub pages within a group of related web pages may then be accessed by clicking on “more” or “back” buttons to effectively stroll through a group of related web pages.

### BRIEF DESCRIPTION OF THE DRAWINGS

Additional advantages and features of the present invention will become apparent from the subsequent description and the appended claims, taken in conjunction with the accompanying drawings, wherein:

FIG. 1 (PRIOR ART) is a schematic illustration of a traditional web site hierarchical having a parent/child node configuration;

FIG. 2 (PRIOR ART) is a schematic illustration of a home page including a site map, a graphic element, and text;

FIG. 3 is a schematic illustration of a computing device connected via the internet to a web site server and a database;

FIG. 3A is a schematic illustration of computing device 140 according to a preferred embodiment of the present invention;

FIG. 3B is a schematic illustration of a computing device in the form of a cellular telephone or a personal digital assistant (“PDA”) according to an alternate embodiment of the present invention;

FIG. 3C is a schematic illustration of a computing device in the form of a television-connected computing device, such as webTV (R) or Nintendo (R), according to an alternate embodiment of the present invention;

FIG. 4 is a schematic illustration of a web site web page as displayed within a browser on a user computing device;

FIG. 5 is a schematic illustration of web site directory page according to an embodiment of the present invention;

FIG. 6 is a detailed view of a page navigation section, including a strolling control section, of the navigation bar illustrated in FIG. 5;

FIG. 7 is a detailed view of a strolling control section 216 according to an alternate embodiment of the present invention;

FIG. 8 is a schematic illustration of a web site directory listing of a preferred embodiment facilitating use of additional directories without use of scroll bars;

FIG. 9 is a schematic illustration of a second directory page according to an embodiment of the present invention;

FIG. 10 is a schematic illustration of a third directory page according to an embodiment of the present invention;

FIG. 11 is a schematic illustration of an individual web page in a web site according to an embodiment of the present invention;

FIG. 12 is a schematic illustration of a web tree for web site navigation according to an embodiment of the present invention;

FIG. 13 is a schematic illustration of a web site first settable menu on a navigation bar according to an embodiment of the present invention; and

FIG. 14 is a flowchart of operations for presenting a web page on a browser of a user computing device.

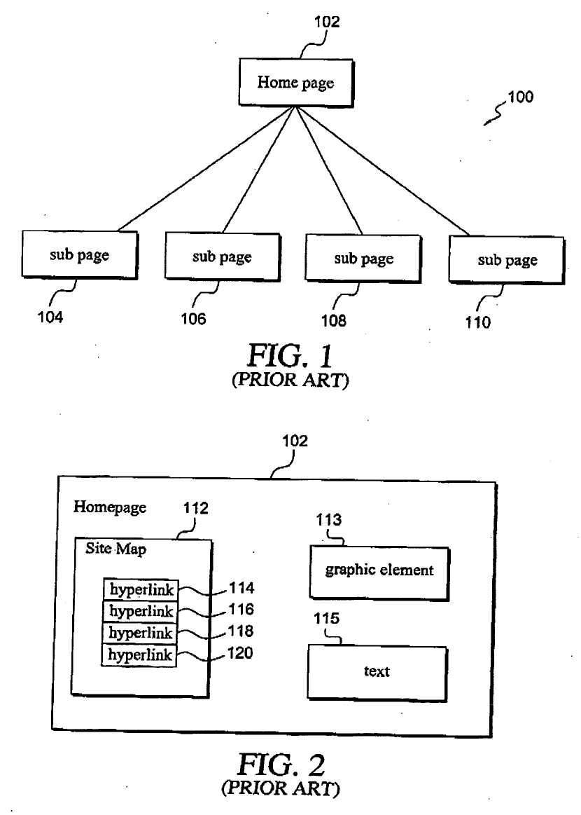

### DETAILED DESCRIPTION OF THE PREFERRED EMBODIMENTS

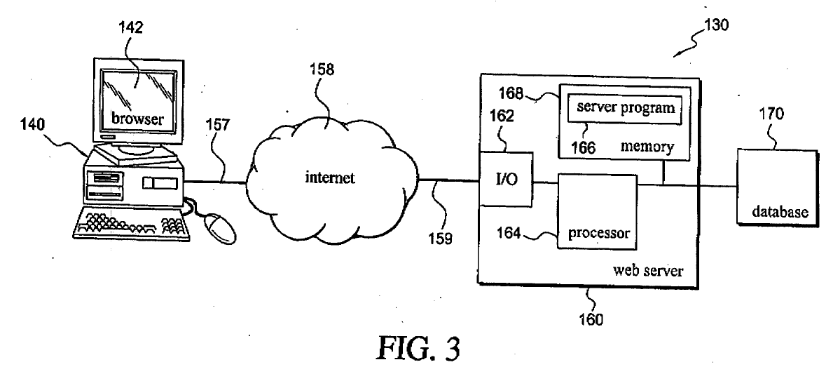

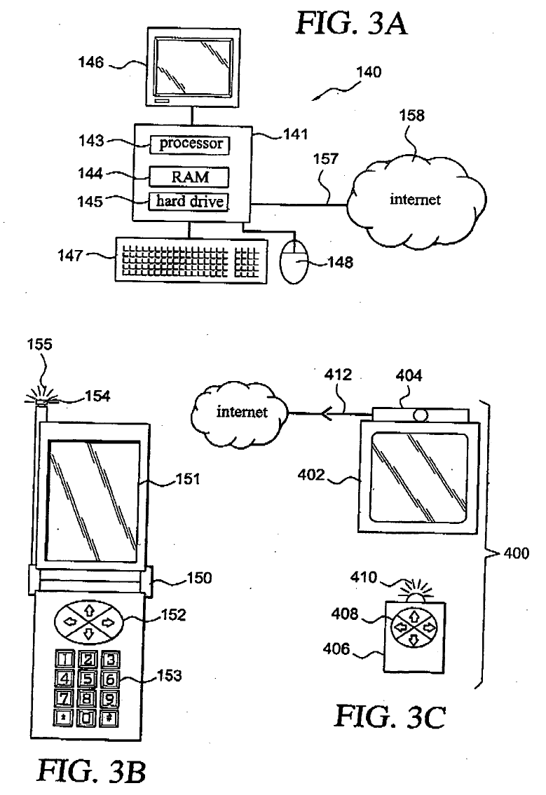

With reference now to the figures, and in particular FIG. 3, a system 130 for communicating information over the internet is provided in accordance with a preferred embodiment of the present invention. System 130 includes a computing device 140 connected to the internet 158 by way of communication line 157. The internet is then connected to web server 160 by way of communication line 159. FIG. 3 therefore represents a general illustration of a computing device that may be used in connection with the present invention.

FIG. 3A is a schematic illustration of computing device 140 according to a preferred embodiment of the present invention. Preferably, computing device 140 includes computer 141 that communicates with the internet 158 by way of communication line 157. Computer 141 has a processor 143, random access memory 144, hard drive 145, video display 146, a data entry device 147, and a cursor control device 148 under control of an operating system. The operating system is stored on hard drive 145 and is loaded into random access memory 144 to control computing device 140. A browser 142, which is a computer client program, provides a graphical user interface (“GUI”) for directing communication with the internet 150 in cooperation with the data entry device 147 and cursor control device 148. As illustrated in FIG. 3A, cursor control device 148 is preferably a mouse, and data entry device 147 is preferably a keyboard. Keyboard 147 may also function as a cursor control device, and mouse 148 may also function as a data entry device.

FIG. 3B is a schematic illustration of a computing device 150 in the form of a cellular telephone or a personal digital assistant (“PDA”) according to an alternate embodiment of the present invention. Computing device 150 includes a video display 151 under control of an internal processor and memory. Computing device 151 includes a cursor control device 152 and data entry device 153. Computing device 150 communicates with the internet 158 by way of a cellular signal communicated by way of antenna 154 using cellular signal 155. When computing device 150 is a cellular telephone, text data and cursor control are provided in a manner known to operators of cellular telephones. Likewise, when computing device 150 is the form of a PDA, text data and cursor control are provided in a manner known to operators of such PDAs.

FIG. 3C is a schematic illustration of a computing device 400 in the form of a television-connected computing device, such as webTV (R) or Nintendo (R), according to an alternate embodiment of the present invention. A television 402 interacts with the internet by way of computing console 404. Computing consol 404 communicates with the user by way of a control module 406. The computing console 404 is connected to the internet 158 by way of connection line 412. The control module 406 includes a cursor control device 408 for controlling cursor operations displayed on television 402. Cursor control device 408 may communicate with computing consol 404 by way of infra-red signal 410. Alternately, cursor control device 408 may communicate with computing console 404 by way of a fixed electrical line, or through radio communication.

FIG. 3 illustrates web server 160, which arranges information stored in database 170 for interpretation and display by computer 140. Web server 160 includes I/O interface 162 to direct communication with the internet 150. Content distribution and reception from web server 160 is controlled by processor 164 in accordance with server program 166 stored in memory 168. When a user operates browser 142 to select content from web server 160, server program 168 retrieves content such as tags, rules, attributes, fields, text, links, tables, frames, icons, and graphic images from database 170, and arranges the content into a format for display. Database 170 is preferably a dedicated database server comprising hardware and software in communication with web server 160. Alternatively, database 170 could be database server software stored in web server 160 and running on processor 164 as a separate software application. As set forth below, web server 160 shall be interpreted to collectively include all forms of server and database configurations which are known to those skilled in the art. The procedure for controlling operation of web server 160 is outlined in greater detail below.

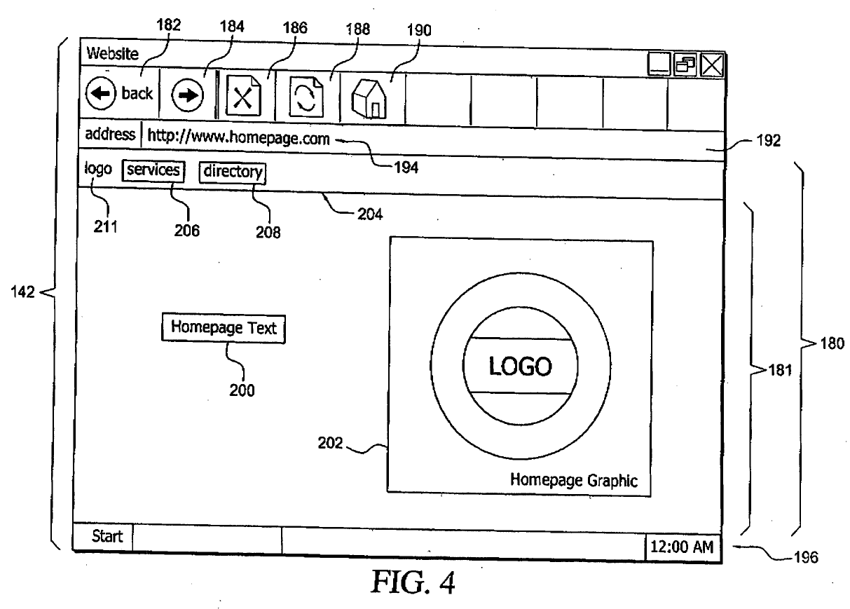

FIG. 4 is a schematic illustration of a web site web page 180 as displayed within browser 142, which is software operating on a user computing device, as set forth above. Browser 142 includes a number of buttons, including back button 182, forward button 184, stop loading button 186, refresh button 188, and home button 190. Traditionally, browser 142 enhances usefulness of internet navigation by controlling download of content from web server 160 into memory of the computing device. Back button 182 re-directs a currently displayed web page (n) to a previous web page (n−1), which cached in memory of user computer 140, while forward button 184 returns the displayed web page to the previous page (n) after the back button 182 has been selected. Stop button 186 directs the browser to discontinue loading of a web page into memory of computer 140, and refresh button 188 reloads a web page that has been previously cached in memory of computer 140. Address window 192 displays the web site address 194, which is also known as a Uniform Resource Locator (“URL”). Task bar 196 is part of the operating system, and is visible on the video screen of computer 140 below browser 142. Task bar 196 provides access to other programs on computer 142 and displays a number of user settable attributes, such as the current time.

Web site web page 180 is illustrated as an introductory home page (also known as a splash page) to introduce the web site. Web page 180 includes home page text 200 and home page graphic 202, which are collectively unique web page content that particularly relates to illustrated web page 180. It is readily understood by those skilled in the art that the unique web page content is representative, and is changeable in response to the purpose of each particular web page. According to a preferred embodiment, the unique web page content is dynamically assembled from objects by web server 160 according to a predetermined protocol upon receipt of a request from web browser 142. The dynamic assembly of web page content is discussed in greater detail below. According to an alternate embodiment, the unique web page content is in the form of static code and associated objects resident on web server 160 and which do not require dynamic assembly.

Web page 180 includes a page section 181 and a navigation bar 204. The navigation bar 204 operates as a navigation tool for controlling user interaction with the web site. Navigation bar 204 is also dynamically assembled from objects by web server 160 according to a predetermined protocol upon receipt of a request from web browser 142. Navigation bar 204 and the unique web page content (home page text 200 and home page graphic 202) are seamlessly displayed to the user on browser 142.

Navigation bar 204 includes site identifier 211, first settable menu 206 and directory button 208. Site identifier 211 is static, in that it does not change in appearance as the user navigates through the website. The static nature of site identifier 211 provides continuity across the website and fosters familiarity with the user. Site identifier 211 may be text, a graphic, or a combination thereof. The content of first settable menu 206 is preferably set during website development to provide immediate access to services that may be required by the user. The content accessed by first settable menu 206 is determined in accordance with the requirements of the particular website. In a preferred form, first settable menu 206 is a drop-down style menu that, when selected with the mouse pointer, provides a series of service buttons for selection by the user. The services provided in through first settable menu may include access to pop-up display information, such as business contact information, or may load a web page needed by the user. Alternately, first settable menu 206 may load a dedicated web page upon selection. While the content accessed by first settable menu 206 may change, the style and position of first settable menu 206 within navigation bar 204 is preferably consistent across all content web pages within the web site. First settable menu 206 is described in greater detail below.

Directory button 208 provides access to content that is preferably set during website development to provide immediate access to services that may be required by the user. The content accessed by directory button 208 is determined in accordance with the requirements of the particular website. In a preferred form, directory button 208 provides immediate user access to a web site directory page.

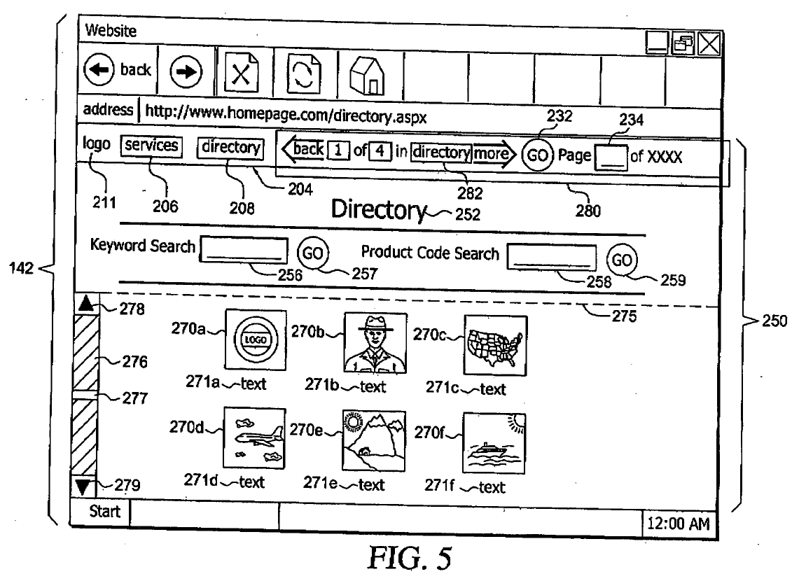

A page navigation section 280, described in greater detail below with reference to FIG. 5, may be optionally provided on navigation bar 204 when the web page 180 is a home page. However, according to a preferred embodiment, the page navigation section 280 is provided within the interior content pages of the web site. Thus, within the set of web pages grouped as a website, each content page includes navigation bar 204 with a page navigation section 280, which is described in greater detail below.

FIG. 5 is a schematic illustration of web site directory page 250 according to an embodiment of the present invention. Directory web page 250 includes text indicia 252 to indicate to the user that they are at the directory. The directory web page 250 is immediately accessible from other web pages of the web site upon selection of directory button 208. According to an embodiment of the invention, the directory web page 250 includes a plurality of navigation tools for locating information in the web site. In addition to the navigation tools present on navigation bar 204, a user may enter keyword search text into a first directory text box 256 and initiate search by selecting first directory jump button 257. The user may also enter search text into a second directory text box 258 and select second directory jump button 259. According to an embodiment, first directory text box 256 is provided for general key word searching of products and services within the web site. Second directory text box 258 is provided for searching products and services according to a predetermined product code. During a guided search, such as during telephone information with a web site help desk, a user may be guided to enter a product code number into the second directory text box 258 to initiate search of desired information. According to an embodiment of the present invention, a first database of search fields are accessed in response to entry of search information in the first directory text box 256, and a second database of search fields are accessed in response to entry of search information in the second directory text box 258. As set forth above, jump page box 234 is activated in response to jump control button 232 to select an entered page number from a group of search fields of all page numbers stored in memory 168 of web server 160. Accordingly, three separate search text boxes may access three separate groups of search fields by way of three respectively corresponding initiator (i.e. jump) buttons.

A group of graphic hyperlink buttons 270 (a-f) are also presented on directory web page 250. Upon selection of a hyperlink button, the user is directed to another web page within the website. The directed web page may be a non-directory content page or another directory page in accordance with parameters selected during website development. The number of hyperlink buttons 270 (a-f) and associated text 271 (a-f) may be changed in accordance with a number of desired sub-directory listings. Each sub-directory, when selected by the user, may in turn load a web page indicating yet another sub-directory, etc. According to the illustrated embodiment six sub-directories may be accessed from the directory web page 250. Preferably, each page within the web site is configured such that there is no scrolling to view additional information and/or content. The absence of scrolling avoids additional confusion for new users of the web site and increases efficiency during interaction with a guide, such as a telephone help desk.

Page navigation section 280 is displayed on navigation bar 204 for all content pages, including the directory web page 250 illustrated in FIG. 5. Page navigation section 280 includes status location indicator 282. The status location indicator 282 is not a button, but is rather content that is displayed in accordance with the loaded page. According to a preferred embodiment, the content of status location indicator 282 is text. However, according to an alternate embodiment, the status location indicator 282 can display a graphic symbol, or a combination of text and graphics. As illustrated in FIG. 5, the text displayed by way of status location indicator 282 is “directory” to indicate to the user that they are currently viewing the directory web page. This text information will change in accordance with web page currently being viewed by the user.

According to a preferred embodiment, the content of each web page is displayed without the use of scroll bars. However, additional information and/or content may also be provided on web page 250. According to an alternate embodiment, optional scroll bar 276 appears on the side of the web page for directing the content that is visible within browser 142. Scroll bar 276 is navigated upwardly by selecting up scroll button 278 and downwardly by selecting down scroll button 279. The viewable information then scrolls with respect to scroll line 275 such that the information and content above scroll line 275 remains visible to the user. Alternatively, the user may navigate the visible content by selecting and moving position scroll button 277 upwardly or downwardly.

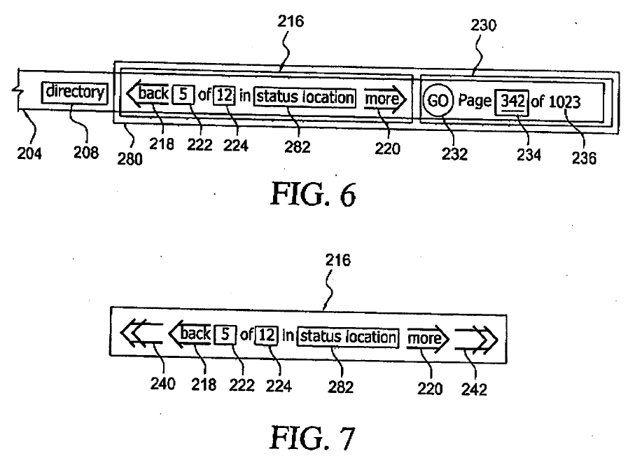

FIG. 6 is a detailed view of page navigation section 280 of the navigation bar 204. As illustrated, the status location indicator 282 displays the text “status location” to generically reflect that the status location will correspond to the content of the currently viewed web page. Page navigation section 280 is disposed adjacent to directory button 208, which is described in greater detail below. According to a preferred embodiment, directory button 208 always returns the user to the directory web page. Page navigation section 280 includes a strolling control section 216 and a jump control section 230.

Strolling control section 216 is illustrated adjacent to directory button 208. Strolling control section 216 allows the user to navigate within a related, pre-determined subset of web pages. Strolling control section 216 includes strolling back button 218 and strolling more button 220 for navigation control. When a user has loaded a web page into browser 142, the user may stroll through a group of related web pages by selecting strolling back button 218 and strolling more button 220.

First page indicia display 222 indicates to the user a unique page number corresponding to the currently displayed page within the subset. Second page indicia display 224 indicates the total number of pages within the subset. By way of example in FIG. 6, the user is currently viewing page 5 (indicated at first page indicia display 222) of a group of 12 (indicated by second page indicia display 224) related pages in a subset. The first page indicia display 222 and second page indicia display 224 provide subset identification information when viewing a subset regardless of how the user has been directed to the web page. According to an embodiment of the invention, the user is constrained from free navigation about the website. The user maintains display of the currently viewed subset through operation of strolling back button 218 and strolling more button 220, which are described in greater detail below. In the illustration of FIG. 6, and by way of example, the user may navigate forward through the subset of 12 related pages by successively selecting strolling more button 220, and the user may navigate backward through the subset of 12 related pages by successively selecting strolling back button 218. Accordingly, the user may not become lost within a complicated web site totaling hundreds of pages.

Strolling control section 216 also includes status location indicator 282. The status location indicator 282 is text that is prepared by the web site to indicate a text name of a page currently viewed by the user. According to an embodiment, status location indicator 282 is presented in a different style configuration than directory button 212 to indicate to the user that the text does not operate as a button. For example, status location indicator 282 may be text that is superimposed onto navigation bar 204 without a background having a first color that is different from the second color of the navigation bar 204.

Jump control section 230 is provided adjacent to strolling control section 216 to assist the user during navigation of the web site. According to an embodiment of the invention, each page of the web site is given a unique page number. Jump control section includes jump control button 232, a jump page box 234 that displays the current page number that the user is viewing, and total page indicator 236 that displays the total number of pages within the web site. As illustrated in FIG. 6, the user is currently viewing page number 342 of a total of 1023 pages. Jump page box 234, in addition to displaying the current page number, is also a user settable text box. Thus, to jump to a different page within the web site, the user simply selects jump page box 234 with the cursor control device and types in a desired page number with a data entry device. When the user selects jump control button 232 with the mouse, the new web page is loaded. Upon loading the new web page, first page indicia display 222 and second page indicia display 224 are automatically updated in accordance with the currently viewed web page.

Jump control section 230 simplifies navigation of complex web sites having hundreds of pages. Because the page numbers appearing in jump page box 234 and total page indicator 236 appear static as viewed in browser 142, a user may associate a particular page number with a desired web page, or web page group. The benefits of page numbering become more pronounced when a user is provided with telephone, print or electronic assistance by a guide during navigation of a complicated web site. Regardless of the web page currently viewed by the user, the guide may simply direct the user to a desired page by instructing the user to type in a desired page number into jump page box 234 and then select jump control button 232.

According to an embodiment of the present invention, web pages are dynamically assembled by web server 160 using content from database 170. Regardless of how the web pages are created by web server 160, each page maintains a unique page number within the web site configuration. It is anticipated that a large commercial web site, such as a large catalog of parts or information or a site containing hundreds of pages of photos may change. However, the benefits of the unique page number remain. Guides in the form of system operators, salespersons, and help desk representatives, are much more skilled at navigating their particular web sites to locate a particular page. Thus, instead of guiding the user through a complicated and time-consuming series of clicks and selections of hyperlinks, the guide may simply direct the user to type in a unique page number. The user is then free to stroll through a group of related web pages without fear of becoming lost within the complicated web site.

A user strolls through a subset of related web pages by using page navigation section 280. The user navigates using strolling back button 218 and strolling more button 220. Because the format of page navigation section 280 remains consistent across differently viewed web pages, the user easily becomes familiar with navigation. Identification of a currently viewed subset is continuously provided by status location indicator 282. Successive forward pages to be viewed within the subset are obtained by the user when strolling more button 220 is selected. According to a preferred embodiment, when the user reaches the end of a subset, e.g. page 12 illustrated in second page indicia display 224 of FIG. 6, and the user continues to select strolling more button 220, the user is directed to page 1 of the next subset. When the subset changes, the status location indicator 282 also changes in accordance with the title of the new subset. Successively regressing pages within the subset are viewed by the user as strolling back button 218 is selected.

According to an embodiment of the present invention, when the user reaches the end of a subset, that is when number “1” is displayed by first page indicia display 222, and the user continues to select strolling back button 218, the user is directed to the last page of a preceding subset. Further, when the subset changes, the status location indicator 282 also changes in accordance with the title of the new subset.

According to an alternate embodiment of the present invention, when the user reaches the end of a subset, that is when number “1” is displayed by first page indicia display 222, and the user continues to select strolling back button 218, the user is re-directed to the directory page corresponding to the subset.

According to an embodiment of the present invention, status location indicator 282 changes in appearance when a subset is changed during strolling by the user. A change in appearance may include change of the background color of status location indicator 282, a change in font color of status location indicator 282, or a change in font style. Alternately, the change in appearance may be more aggressive, such that the background color of status location indicator 282 repeatedly changes color in a blinking fashion for a period of time.

As the user strolls between pages, jump page box 234 also changes in accordance with the newly selected page. Accordingly, the user may continuously and simultaneously view the current page number within the web site (provided by jump page box 234) and the current page number within the subset (provided by first page indicia display 222). Likewise, the user may also continuously and simultaneously view the total number of pages in the web site (provided by total page indicator 236) and the total number of pages within the subset (provided by second page indicia display 224).

Level 2 web pages, i.e. pages below the Directory level, are linked as an ordered list of uniquely identifiable web pages that may be sequentially loaded for display into web browser 142 in reference to a predetermined set. The ordered list is stored in database server 170 of FIG. 3. According to a preferred embodiment, the ordered list is a numerical list with the web pages identified by number. Other forms of unique identification are known to those skilled in the art and may include alphanumeric identification, binary identification, hexadecimal identification, etc.

Each uniquely numbered Level 2 web page is linked in succession within the total number of pages by web page number. In order to sequentially load a next succeeding web page into browser 142, web server 160 adds integer “1” to the current web page number (n), and then assembles web page number (n+1) for display on browser 142. Likewise, to sequentially load a next preceding page into browser 142, web server 160 subtracts integer “1” from the current web page number (n), and then assembles web page number (n−1) for display on browser 142.

FIG. 7 is a detailed view of strolling control section 216 according to an alternate embodiment of the present invention. Strolling control section 216 includes strolling back button 218, strolling more button 220, first page indicia display 222, and second page indicia display 224 as set forth in the above embodiment of FIG. 6. According to the alternate embodiment, strolling first button 240 and strolling last button 242 are provided. Strolling first button jumps to the first page of the listed subset. Likewise, strolling last button jumps to the last page of the subset. According to an optional embodiment, each subset may optionally include general information about the subset on the first page of the subset and an index of all pages of the subset on the last page.

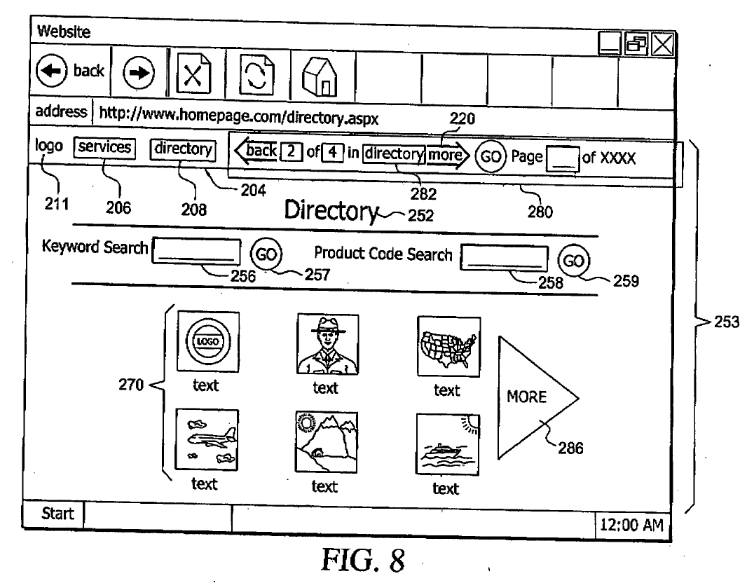

FIG. 8 is a schematic illustration of a web site directory listing of a preferred embodiment facilitating use of additional directories without use of scroll bars. In accordance with the present invention, it has been determined that the use of scroll bars in web page listings introduce additional complexity and inefficiency for web site navigation. However, according to the protocol of very complex web sites, there may exist a situation where a desired number of directory listings greatly exceed the space that is easily viewable on a user's computer screen. Accordingly, it is preferred to show additional directories by way of an additional page or pages. As illustrated in FIG. 8, a conspicuously visible directory more button 286 is provided adjacent to graphic hyperlink buttons 270. When the user clicks directory more button 286, a new page loads into a user's browser with additional directories. In this case, directory more button 286 is redundant to strolling more button 220 provided in navigation bar 280. However, because a new user will be initially guided to the web site directory, and may be some-what unfamiliar with the web site layout, the provision of directory more button 286 (i.e. a second more button) provides a convenient and intuitive mechanism for web site navigation.

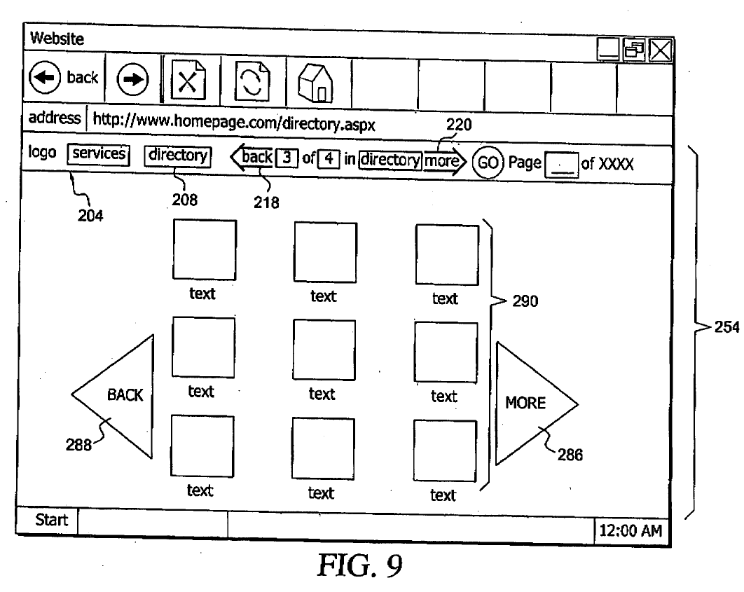

FIG. 9 illustrates a second directory page that will be visible to the user upon selecting the directory more button 286 from the main directory page illustrated in FIG. 8. As illustrated, a plurality of graphic hyperlink buttons 290 are provided for additional web site navigation. The user may stroll backward through the directory pages by selecting directory back button 288, or continue to stroll forward by selecting directory more button 286. In this case, directory back button 288 is redundant to strolling back button 218, and directory more button 286 is redundant to strolling more button 220. It therefore becomes readily apparent that when in the directory subset of web pages, the user may return to the first page of the directory pages subset through three different mechanisms. First, the user may simply select the directory button 208. Second, the user may continually select the directory back button 288. Third, the user may continually select the strolling back button 218.

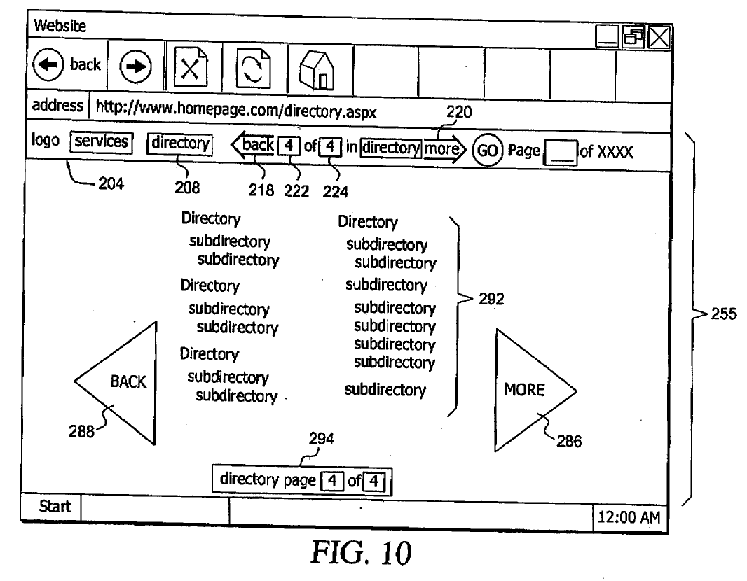

FIG. 10 illustrates a third directory page according to an embodiment of the present invention. As illustrated, a plurality of text style hyperlink buttons 292 are provided as the directory. Further, the hyperlink buttons 292 are tiled in an indented fashion to visually convey subdirectory status. First page indicia display 222 indicates page 3 of the directory, and second page indicia display 224 indicates that there are 20 total pages in the directory subset. According to an embodiment of the invention second page indicia box 294 is provided to convey redundant information to first page indicia display 222 and second page indicia display 224. This redundant information is provided to the user in the directory web pages as a convenient and intuitive mechanism for web site navigation.

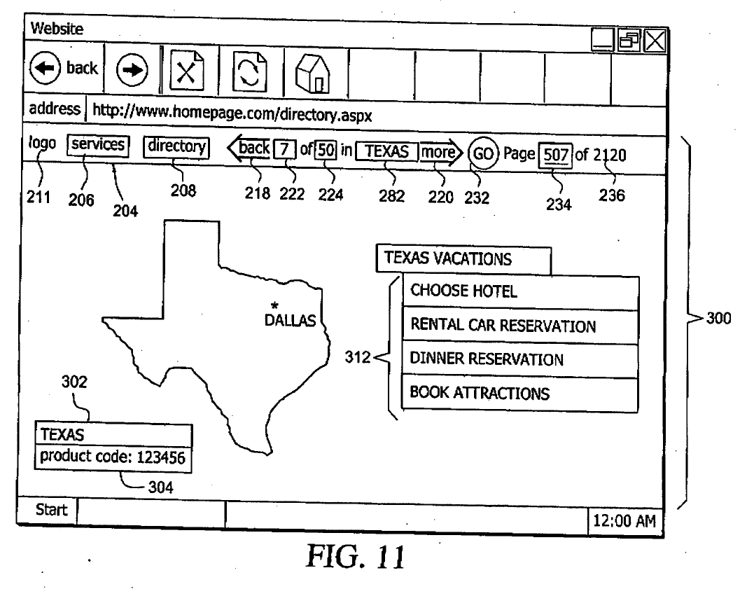

FIG. 11 is a schematic illustration of an individual web page 300 in a web site according to an embodiment of the present invention. Web page 300 is presented as an example of a catalog style web page for a travel club. The user has located page 507 (“Texas”), indicated by jump page box 234, of a possible 2120 web pages within the web site. The total number of web pages within the site is indicated by total page indicator 236. The user may have found page 507 (“Texas”) through a key word search of the term “texas” in the directory web page, a product code search of the term “123456” in the directory web page, through selecting appropriate directories and sub-directories by way of a tree structure initiated in the directory web page, or by typing page number “507” into jump page box 234 from any page and then selecting jump control button 232 from any web page. Jump page box 234 continuously displays the currently viewed web page number, but may also be selected by a cursor control device for entry of a new page number desired by the user.

As illustrated in web page 300, text is provided by way of page text box 302, and the product code is provided by way of product code box 304. The text within text box 302 is preferably indexed within a first field database accessed via web server 160 and the product code within product code box 304 is preferably indexed within a second field database access via web server 160. Status location indicator 282 also indicates to the user that the current web page has a label of “texas.” The user could then navigate within 50 pages of the current web page subset. The user immediately understands that there are 50 pages within the web page subset because second page indicia display 224 indicates the number “50.” The user navigates through the 50 related pages in the subset through operation of strolling back button 218 and strolling more button 220. A plurality of hyperlinks 312 allow the user to request products or services associated with the current web page.

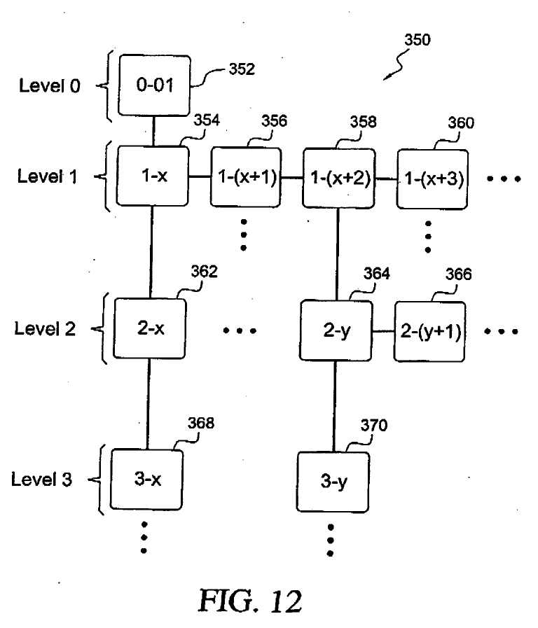

FIG. 12 is a schematic illustration of a web tree 350 for web site navigation according to an embodiment of the present invention. Box 352 is provided in Level 0 and represents a home page. By way of example, box 352 “0-01” corresponds to web page 180 in FIG. 4 in the form of a home page.

Boxes 354, 356, 358, and 360 are provided in Level 1 and represent a directory listing. By way of example, box 354 “1−x” corresponds to web page 250 (a web site directory page) illustrated in FIG. 5. Likewise, box 356 “1−(x+1)” corresponds to web page 253 illustrated in FIG. 8, box 358 “1−(x+2)” corresponds to web page 254 illustrated in FIG. 9, and box 360 “1−(x+3)” corresponds to web page 255 illustrated in FIG. 10.

Boxes 362, 364, and 366 are provided in Level 2 and represent item pages dedicated to a particular product or service. For example, box 362 “2−x” corresponds to web page 300 illustrated in FIG. 11.

Boxes 368, and 370 are provided in Level 3 and represent web pages that may be accessed from a Level 2 box. The user may not stroll among Level 3 boxes or any other boxes below Level 2.

Navigation downward through web tree 350 is provided by way of selecting hyperlinks from a directory or subdirectory listing, such as between Levels 1 to 2. According to a first alternative, the user enters a selected web page through a key word or product code search. According to a second alternative, the user navigates to a web page by entering a unique page number for the desired web page into jump page box 234 in navigation bar 204. Once the user enters a web page that is part of a desired subset, which is schematically illustrated as level 3, the user strolls between related pages. The user is confined by way of the stroll control buttons, that is, strolling back button 218 and strolling more button 220, such that the user may not unknowingly become lost in a undesired subset. As set forth above, a user strolling on level three will navigate between subsets through use of strolling back button 218 or strolling more button 220 upon reaching a beginning or end of the subset.

With reference to FIG. 5, FIG. 6, and FIG. 12, the strolling back button 218 and strolling more button 220 do not function in the same manner as the back button 182 and forward button 184. The back button 182 simply returns the user to previously viewed web pages that are stored in cache memory of the computing device in seriatim fashion. In contrast, the strolling back button 281 directs the user to the immediately preceding web page in a subset. Thus, if a user were to advance to a web page indicated by box 366 illustrated in FIG. 12 by typing a number into jump page box 234 illustrated in FIG. 6, a selection of strolling back button 281 would direct the user to the web page indicated by box 364 illustrated in FIG. 12. In contrast, were the user to select back button 182 illustrated in FIG. 5 while viewing the web page of box 366, the user would be directed to the previously viewed web page.

Likewise, forward button 184 illustrated in FIG. 5 returns the user to a previously viewed web page after the back button 182 has been pressed. In contrast, strolling more button 220 directs the user to the next web page in the subset. Thus, if a user were to advance to a web page indicated by box 364 by typing a number into jump page box 234, a selection of strolling back button 281 would direct the user to the web page of box 366. In contrast, were the user to select forward button 184 while viewing web page box 364 nothing would happen because the user had not previously selected the back button 182.

Each Level 2 page is an item page that is strollable when the user is at other Level 2 pages. The Level 2 stroll sequence of pages is determined by directory layout. According to a preferred embodiment, the majority of content information is provided in Level 2, with each Level 2 web page including a definable set of information. Thus, once the user navigates to a Level 2 web page, through the various methods set forth above, the user is permitted to stroll through a group of related web pages by simply using the strolling more button 220 or strolling back button 218.

Each web page includes objects, i.e. graphics, video, text, that can contain page links. Page links refer to either pages within the web site or external URLs. When clicking on a page link that refers to another page in the web site, the web browser 142 has traversed down a level (n+1) where n is the level of the referring page. When web browser 142 displays pages lower in the tree, e.g. the web page of box 362 in FIG. 12, the strolling back button 218 of FIG. 6 functions as an up button which pops the user back to referring page 354 illustrated in FIG. 12. This is performed recursively as web browser 142 traverses down the navigation tree of FIG. 12.

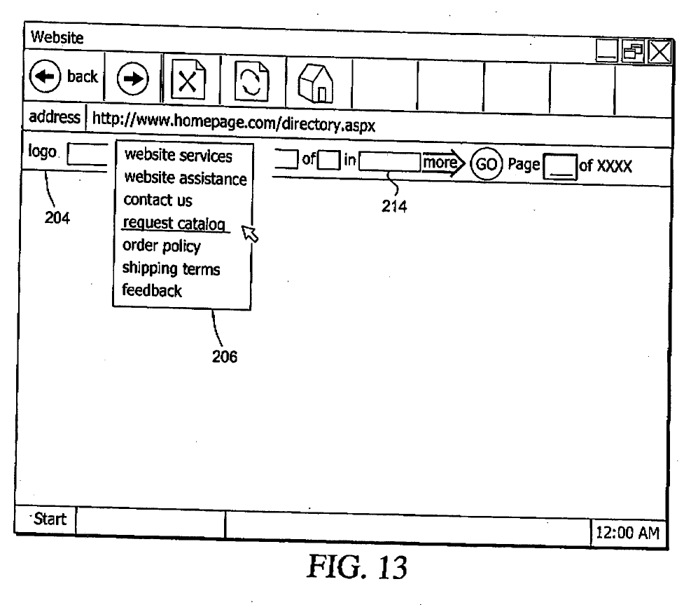

FIG. 13 is a schematic illustration of a web site first settable menu 206 on navigation bar 204. As illustrated, a plurality of web site services are available for selection by the user, such as web assistance, contact us, request catalog, order policy, shipping terms, and feedback. First settable menu 206 is accessible from all pages of the web site due to its placement on navigation bar 204. According to an alternate embodiment, a second settable menu may also be provided on navigation bar 204 for immediate access by the user during navigation of all related web pages.

According to a preferred embodiment, the present invention is implemented by way of software running on web server computer 160 in combination with software running on database server computer 170. The database server is preferably running Microsoft Windows 2003 Server and uses Microsoft SQL Server 2000 as its database application on Microsoft.NET platform. The database on the database server stores all content of particular site. Content is defined as any user provided data during the build phase of the web site. Examples of content include images, copy, navigation links and form inputs.

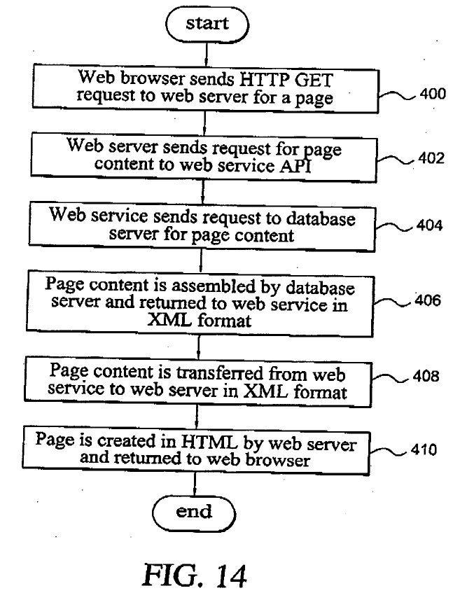

FIG. 14 is a flowchart of operations for presenting a web page on browser 142 of user computing device 140. In operation 400, browser 142 makes a request for a web page from web server software running on web server computer 160. By default, if a page number is not specified, the request defaults to the home page. In operation 402, the web server software sends a request for page content to web service API (“application program interface”). The web service provides a platform that is able to service a plurality of different viewing platforms, such as internet browsers, PDAs (“personal digital assistants”), and cell phones. In other words, the web browser issues a request GET to retrieve a page (page.aspx?p=<pageno>). The web server then parses the page number and issue a request to a web service to get the content of a page.

The web service is an additional program preferably running on web server computer 160. However, the web service program could be implemented on a dedicated web service computer. In operation 404, the web service sends a request for page content and layout information to database server software running on database computer 170. According to a preferred embodiment, the request is provided through an ADO.NET interface. The database uses stored procedures to generate the results in XML and returns it back to the web server. In operation 406, page content is assembled by the database sever software and returned to the web service in XML format.

In operation 408 the XML page content and XSL layout information is transferred from the web service to the web server in XML format. In operation 410, the web server transforms the XML page content and the XSL formatted information into HTML formatted information, and returned for display on web browser 142.

According to a preferred embodiment the web server uses the Microsoft's .NET framework. The .NET Framework is a development and execution environment that allows different programming languages & libraries to work together seamlessly to create Windows-based application. According to a preferred embodiment, programming is performed in C# and web pages were built using ASP.NET.

The web service is an application component accessible over open protocols using a distributed component technology. The web service is used to decouple content from display medium. For example, a web browser is only one form of how to display the data. On the other hand, the web service provides formatting that is compatible with PDAs (“programmable digital assistants”) or cell phone to convey information. In using web services, any form of display can access the content and display it in any way, via web browser or speech technology etc.

Navigation Bar Create Procedure

According to a preferred embodiment, XML for the navigation bar 204 illustrated in FIG. 5 is created for display on an internet browser in accordance with code executed on web server 160. The code is written in C# language with Microsoft SQL Server's stored procedure and compiled by Visual Studio 2003 program. The compiled code is then executed under IIS 6.0 running the Microsoft Windows 2003 operating system. The web server 160 accesses a web service, which is a program stored along with web server 160. The web service provides XML formatted data on a particular page and navigation information for the particular page. The web service obtains the data from the database 170 running Microsoft SQL Server 2000 using the ADO.NET interface written in C#. The database 170 includes a plurality of stored procedures, e.g. sp_XmlPageNav, sp_XmlMenuBar, and sp_XMLPage, that are called to produce the XML formatted data. Once web server 160 obtains the XML formatted data from the web service, the web server 160 uses XSL to transform the data into an HTML format. This transformation is executed with a code procedure that is written in C#.

The stored procedure sp_XmlPageNav in database 170 creates the content to make page navigation section 280 of the navigation bar 204 of FIG. 6. An example of procedure sp_XmlPageNav follows:

| ... | |
|---|---|
| CREATE PROCEDURE [dbo].[sp_XmlPageNav] | |
| (@storeId | [int], |
| @pageNo | [int]) |
| ... | |

A number of variables used in the create procedure are then declared. The variables correspond to the web site's unique id and the page number of the requested page.

| | |
|---|---|
| ... | |
| SELECT 1 | AS Tag, |
| NULL | AS Parent, |
| @totalPages | AS [PAGE_NAVIGATOR!1!totalPages], |
| btq_page.page_no | AS [PAGE_NAVIGATOR!1!pageNo], |

```
    CAST(btq_directory.[name] AS NVARCHAR(10)) AS
  [PAGE_NAVIGATOR!1!directory],
    ISNULL(btq_page.directory_seq, 1) AS
  [PAGE_NAVIGATOR!1!directorySeq],
    ISNULL(btq_directory.no_pages, 1) AS
  [PAGE_NAVIGATOR!1!directoryNoOfPages],
```

| | |
|---|---|
| btq_stroll.next_page | AS [PAGE_NAVIGATOR!1!nextPage], |
| btq_stroll.prev_page | AS [PAGE_NAVIGATOR!1!prevPage], |
| CASE | |

WHEN btq_stroll.next_page IS NOT NULL OR
btq_stroll.prev_page IS NOT NULL THEN 1

| | |
|---|---|
| ELSE 0 | |
| END | AS [PAGE_NAVIGATOR!1!isStroll] |
| FROM | |
| ... | |
| FOR XML EXPLICIT | |
| ... | |

The set of tables are then joined in accordance with the above to retrieve the page navigator data set, using the constraints page_id=@pageId and store_id=@store_id to complete the XML procedure.

The database's stored procedure sp_XmlPageNav creates the content to make the first settable menu 206 of FIG. 4, as follows:

...
CREATE PROCEDURE [dbo].[sp_XmlMenuBar]
(@storeId [int])
...

A number of variables are then declared. The variables correspond to the web site's unique id. Services menus, i.e. first settable menu 206, are independent of page. Several queries are combined to create a hierarchical menu structure.

...

| | |
|---|---|
| SELECT 1 | AS Tag, |
| NULL | AS Parent, |
| [name] | AS [MENUS!1!name], |
| NULL | AS [DROPDOWN_MENU!2!id], |
| NULL | AS [DROPDOWN_MENU!2!name], |
| NULL | AS [MENU_ITEM!3!pageId], |
| NULL | AS [MENU_ITEM!3!href], |
| NULL | AS [MENU_ITEM!3!name] |
| FROM | |
| ... | |

The set of tables joined to retrieve the web site's services navigator data set, using the constraints store_id=@store_id.

| | |
|---|---|
| ... | |
| UNION ALL | |
| SELECT 2 | AS Tag, |
| 1 | AS Parent, |
| NULL | AS [MENUS!1!name], |

```
    btq_service_group.[id] AS [DROPDOWN_MENU!2!id],
    btq_service_group.[name] AS [DROPDOWN_MENU!2!name],
```

| | |
|---|---|
| NULL | AS [MENU_ITEM!3!pageId], |
| NULL | AS [MENU_ITEM!3!href], |
| NULL | AS [MENU_ITEM!3!name] |
| FROM | |
| ... | |

The set of tables are then joined to retrieve the set of services, using the constraints store_id=@store_id.

| ... | |
|---|---|
| UNION ALL | |
| SELECT 3 | AS Tag, |
| 2 | AS Parent, |
| NULL | AS [MENUS!1!name], |
| btq_service_group.[id] AS [DROPDOWN_MENU!2!id], | |
| NULL | AS [DROPDOWN_MENU!2!name], |
| page_id | AS [MENU_ITEM!3!pageId], |
| url | AS [MENU_ITEM!3!href], |
| title | AS [MENU_ITEM!3!name] |
| FROM | |
| ... | |

FOR XML EXPLICIT

The set of tables are then joined to retrieve services belonging to each of the service group, using the constraints store_id=@store_id.

PAGE CREATE PROCEDURE

According to a preferred embodiment, XML for a displayed page, such as page 300 illustrated in FIG. 11, is created with code running on web server 160 according to a PAGE CREATE PROCEDURE, written in Microsoft (R) C#. The database's stored procedure sp_XmlPage creates the content to make the page 300 of FIG. 11, as follows:

...
CREATE PROCEDURE [dbo].[sp_XmlPage]

| | |
|---|---|
| (@storeId | int], |
| @pageNo | [int]) |

...

First, a number of variables used in the create procedure are declared. The variables correspond to the web site's unique id and the page number of the requested page. The body of the procedure combines several queries to create a hierarchical page structure containing various components such as images, page links and text.

| | |
|---|---|
| ... | |
| SELECT 1 | AS Tag, |

| | |
|---|---|
| NULL | AS Parent, |
| title | AS [PAGE!1!title], |

| | |
|---|---|
| btq_page.[description] | AS [PAGE!1!description], |

| | |
|---|---|
| keywords | AS [PAGE!1!keywords], |
| template_id | AS [PAGE!1!template], |

| | |
|---|---|
| btq_template.layer | AS [PAGE!1!layer], |

| | |
|---|---|
| btq_page.[id] | AS [PAGE!1!pageid], |
| page_no | AS [PAGE!1!pageno], |
| bgcolor | AS [PAGE!1!bgcolor], |
| bgtype | AS [PAGE!1!bgtype], |
| NULL | AS [PAGE_LAYOUT!2!id], |
| NULL | AS [IMAGETEXT_DETAILS!3!pos], |
| NULL | AS [IMAGETEXT_DETAILS!3!layout], |
| NULL | AS [IMAGE_DETAILS!4!pos], |
| NULL | AS [IMAGE_DETAILS!4!height], |
| NULL | AS [IMAGE_DETAILS!4!width], |
| NULL | AS [IMAGE_DETAILS!4!imgext], |
| NULL | AS [IMAGE_DETAILS!4!caption], |
| NULL | AS [PAGE_LINK!5!page_id], |
| NULL | AS [PAGE_LINK!5!url], |
| NULL | AS [TEXT_DETAILS!6!height], |
| NULL | AS [TEXT_DETAILS!6!width], |
| NULL | AS [TEXT_DETAILS!6!copy], |
| NULL | AS [IMAGE_DETAILS!7!pos], |
| NULL | AS [IMAGE_DETAILS!7!height], |
| NULL | AS [IMAGE_DETAILS!7!width], |
| NULL | AS [IMAGE_DETAILS!7!imgext], |
| NULL | AS [IMAGE_DETAILS!7!caption], |
| NULL | AS [PAGE_LINK!8!page_id], |
| NULL | AS [PAGE_LINK!8!url], |
| NULL | AS [TEXT_DETAILS!9!pos], |
| NULL | AS [TEXT_DETAILS!9!height], |
| NULL | AS [TEXT_DETAILS!9!width], |
| NULL | AS [TEXT_DETAILS!9!copy], |
| NULL | AS [PRODUCT_DETAILS!10!pos], |
| NULL | AS [PRODUCT!11!id], |
| NULL | AS [PRODUCT!11!pict_id], |
| NULL | AS [PRODUCT!11!sku], |
| NULL | AS [PRODUCT!11!description], |
| NULL | AS [PRODUCT!11!price], |
| NULL | AS [PRODUCT!11!has_modifier], |
| NULL | AS [FORM_DETAILS!12!id], |
| NULL | AS [FORM_DETAILS!12!pos], |
| NULL | AS [FORM_DETAILS!12!maxInputs], |
| NULL | AS [FORM_DETAILS!12!description], |
| NULL | AS [INPUT_GROUP!13!group], |
| NULL | AS [INPUT!14!id], |
| NULL | AS [INPUT!14!type], |
| NULL | AS [INPUT!14!description], |
| NULL | AS [INPUT!14!required], |
| NULL | AS [INPUT!14!width], |
| NULL | AS [RADIO_GROUP!15!group], |
| NULL | AS [INPUT!16!id], |
| NULL | AS [INPUT!16!type], |
| NULL | AS [INPUT!16!description], |
| NULL | AS [INPUT!16!required] |

FROM
...
FOR XML EXPLICIT
...

The set of tables are then joined to retrieve the page data set. This contains information on position, type of component and its content.

XML OUTPUT

In accordance with the above, the resulting XML data produced is as follows:

```
...
<?xml version=“1.0” ?>
- <PAGE template=“700” layer=“T” pageid=“415” pageno=“352” bgcolor=“FFFFFF”>
  - <PAGE_LAYOUT id=“1”>
    <IMAGE_DETAILS pos=“3” height=“324” width=“324” />
    <TEXT_DETAILS pos=“1” height=“90” width=“770” copy=“<span
    style=‘font-name:Arial,Verdana;font-size:18.0pt’>CUSTOM
    ORDERS</span>” />
    <TEXT_DETAILS pos=“2” height=“324” width=“440” copy=“<div
    align=‘center’ ><table style=‘BORDER-LEFT: #999999 1px solid;
    BORDER-TOP: #999999 1px solid;BORDER-RIGHT: #999999 1px solid;
    BORDER-BOTTOM: #999999 1px solid;MARGIN: 0px 0px 0px; FONT-
    FAMILY: Anal, sans-serif; FONT-SIZE: 11pt’> <tr> <td>BrattleWorks
    does Custom Orders. Routinely, we will customize the dimensions of our
    standard panels and gates. We can also modify our products to fit your
    specific design. A simple sketch from you often helps us understand your
    requirements. <p> Contact BrattleWorks 617.864.2110, fax 617.354.4246
    or  email  <a
    href=‘mailto:bw@brattleworks.com’>bw@brattleworks.com</a> with your
    requirements.</td></tr></table></div>” />
  </PAGE_LAYOUT>
- <NAVIGATION_BAR>
  - <MENUS name=“BrattleWorks”>
    - <DROPDOWN_MENU id=“1” name=“Services”>
      <MENU_ITEM pageId=“414” name=“Contact Us” />
      <MENU_ITEM pageId=“415” name=“Custom Orders” />
      <MENU_ITEM href=“download.aspx” name=“Downloads” />
      <MENU_ITEM pageId=“412” name=“Project Assistance” />
      <MENU_ITEM href=“request.aspx” name=“Request a Catalog” />
      <MENU_ITEM pageId=“413” name=“Satisfaction Guarantee” />
      <MENU_ITEM pageId=“416” name=“Shipping Terms (Freight)” />
      <MENU_ITEM pageId=“411” name=“Shipping Terms (Package)”
      />
      <MENU_ITEM href=“feedback.aspx” name=“Site Feedback” />
      <MENU_ITEM href=“cart.aspx” name=“View Cart” />
    </DROPDOWN_MENU>
    </MENUS>
    <PAGE_NAVIGATOR totalPages=“380” pageNo=“352” directorySeq=“1”
      directoryNoOfPages=“1” isStroll=“0” />
    </NAVIGATION_BAR>
  </PAGE>
...
```

This data is then passed to web server 160. The web server 160 obtains the necessary XSL template to transform the XML data into HTML. The procedure written in C# is called to HTML(XmlDocument document, XSLTransform xsl).

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

We claim:

1. A navigation tool for navigating a web site, said web site comprising a plurality of web pages that are configured by a web server and displayable by an internet browser, said plurality of web pages being linked as a first set of web pages and said plurality of web pages being linked as at least a second set of web pages, comprising:
a jump control section comprising a first indicator for providing a visual indication on an internet browser of a total number of a first set of linked web pages available for access by a user; and
a strolling control section comprising a second indicator for providing a visual indication on the internet browser of a total number of a second set of linked web pages available for access by the user.

2. The navigation tool according to claim 1, wherein a web page currently displayed by the internet browser is a member of the first set of linked pages and the second set of linked pages.

3. The navigation tool according to claim 2, said jump control section further comprising:
a jump page box providing a numerical indication of the current web page within the total number of the first set of linked web pages.

4. The navigation tool according to claim 3, wherein the jump page box is selectable by a user operating the internet browser such that the user may enter a desired page number into the jump page box, said jump control section further comprising:
a jump control button, which is selectable by the user operating the internet browser to direct a web server to transmit for display a web page corresponding to the desired page number.

5. The navigation tool according to claim 2, further comprising:
a status location identifier providing a visual identifier for display on the internet browser corresponding to the current web page.

6. The navigation tool according to claim 1, wherein a web page currently displayed by the internet browser is a member of the first set of linked pages and the second set of linked pages, said strolling control section further comprising:
a first page indicia display providing a numerical indication of the current web page within the total number of the second set of linked web pages; and
a second page indicia display providing a numerical indication of the total number of the second set of linked web pages.

7. The navigation tool according to claim 1, wherein a web page currently displayed by the internet browser is a member of the first set of linked pages and the second set of linked pages, said strolling control section further comprising:
a strolling back button which is selectable by the user operating the internet browser to direct a web server to transmit for display a web page corresponding to a preceding page of the second set of linked pages; and
a strolling more button which is selectable by the user operating the internet browser to direct a web server to transmit for display a web page corresponding to a succeeding page of the second set of linked pages.

8. The navigation tool according to claim 6, wherein if the strolling back button is selected when the current page is a first page of the second set of linked pages, the web server is directed to transmit for display a web page corresponding to a third set of linked pages different from the second set of linked pages.

9. The navigation tool according to claim 6, wherein if the strolling more button is selected when the current page is a last page of the second set of linked pages, the web server is directed to transmit for display a web page corresponding to a first page of a third set of linked pages different from the second set of linked pages.

10. The navigation tool according to claim 1, wherein a directory page of said web site is a member of the first set of linked pages and a member of a third set of linked pages different from said second set of linked pages, said navigation tool further comprising:
a directory button which is selectable by the user operating the internet browser to direct a web server to load the directory page as the current page when the current page is a member of the second set of linked pages.

11. A method of navigating a plurality of web pages that are configured as a web site by a web server from a user computer having a cursor control device and running an internet browser, said plurality of web pages being linked as a first set of web pages and at least a second set of web pages, said method comprising:
loading a first web page into an internet browser from a web server, the web page comprising a first indicator of a total number of a first set of linked web pages available for access by a user, a second indicator of a total number of a second set of linked web pages available for access by the user, and a strolling button;
selecting the strolling button displayed on the internet browser with a cursor control device to instruct the web server to transmit second web page content of a second page of the second set of linked web pages; and
loading the second web page content into the internet browser from the web server.

12. The method of navigating a website according to claim 11, further comprising:
loading a status location identifier providing a visual identifier for display on the internet browser corresponding to the loaded second page content.

13. The method of navigating a website according to claim 11, further comprising:
loading a jump page box providing a visual identifier for display on the internet browser corresponding to the loaded second page content.

14. The method of navigating a website according to claim 13, wherein the visual identifier provided by the jump page box is a page number, further comprising:
loading a jump control button into the internet browser;
selecting the jump page box with the cursor control device;
entering a new page number into the selected jump page box with a computer keyboard; and
selecting the jump control button with the cursor control device to instruct the web server to transmit a third web page content of a third web page of the first set of linked web pages.

15. The method of navigating a website according to claim 14, further comprising:
reloading the first indicator into the internet browser corresponding to the third web page content; and
reloading the second indicator into the internet browser corresponding to the third web page content.

16. A method of navigating a plurality of web pages that are configured as a web site by a web server from a user computer having a cursor control device and running an internet browser, said plurality of web pages being linked as a first set of web pages and at least a second set of web pages, said method comprising:
loading a first web page content and a web page navigation bar into an internet browser from a web server, the navigation bar comprising a jump control button, a jump page box, and a total page indicator;
conducting telephone, print, or electronic communication with a web site guide to verbally receive a unique page number corresponding to a second web page of the first set of web pages;
entering the unique page number into the jump page box with a computer keyboard;
selecting the jump control button with the cursor control device to instruct the web server to transmit a second web page corresponding to the unique page number; and
loading the second web page into the internet browser from the web server.

17. The method of navigating a website according to claim 16, further comprising:
loading a strolling control section into the internet browser corresponding to the second web page, the strolling control section comprising a first page indicia display corresponding to a unique page number of the second set of web pages, and a second page indicia display corresponding to a total number of pages in the second set of web pages.

18. The method of navigating a website according to claim 17, further comprising:
loading a strolling button into the internet browser from the web server;
selecting the strolling button with the cursor control device to instruct the web server to transmit a third web page content of a third page of the second set of linked web pages; and
loading the third web page content into the internet browser from the web server.
